(19) United States
(12) Patent Application Publication
(10) Pub. No.: US 2019/0024633 A1
(43) Pub. Date: Jan. 24, 2019

(54) WINDMILL GENERATOR ASSOCIATED WITH A CONSTRUCTION

(71) Applicants: Luciano Enrique CIANNI, Beccar, Provincia de Buenos Aires (AR); Juan Pablo PIZARRO, Don Torcuato, Provincia de Buenos Aires (AR); Alejandro Josè KLARENBERG, Dintelord (NL)

(72) Inventors: Roberto Horacio Blanco, Don Torcuato (AR); Alejandro Josè Klarenberg, Don Torcuato (AR); Juan Pablo Pizarro, Don Torcuato (AR); Luciano Enrique Cianni, Beccar (AR); Carlo Conrado Bosio Blanco, Sabadell (ES)

(21) Appl. No.: 16/081,435

(22) PCT Filed: Feb. 28, 2017
(86) PCT No.: PCT/IB2017/000259

§ 371 Date: Aug. 31, 2018

(30) Foreign Application Priority Data
Mar. 1, 2016 (AR) P20160100536

(51) Int. Cl. F03D 3/04; F03D 13/20; F03D 9/45

(52) U.S. Cl. CPC F03D 3/0418; F05B 2240/9112; F03D 9/45; F03D 13/20

(57) ABSTRACT

A construction (1) defining a volume submerged in an air-stream (10), with at least one surface (6) against which the air current impinges, directing, acceleration and laminating an air-flow against the lateral (6) of the construction (6) having at least one wind-mill generator (2) attached to said lateral (6) in an area where there is still no separation of said laminar air-flow (11) form the construction (1). Faced with said generator (2), is arranged at least one plate (9), the wind generator (2) being positioned between said plate (9) and said portion of the lateral wall, determining a tunnel (14) with an air inlet and outlet of the air-stream impinging on the blades of the wind-mill generator (2). The inlet of the air-stream into said tunnel (14) directed towards the blades of the wind-mill generator is placed adjacent the largest section of the perimeter of said construction (1), perpendicular to the direction of incidence of the wind-stream.

### FIELD OF THE INVENTION

This instant invention finds its field of application in the electric energy generation extracted from the potential energy contained in an airflow or airstream. More specifically, this instant invention is related to an airflow submerged construction, directing and accelerating said airflow through at least a windmill generator associated with said construction. By the term “construction” it is intended all kind of dwellings, buildings, factories, stores, sheds, or the like.

### BACKGROUND OF THE INVENTION

Since ancient times man has managed to extract the powerful energy carried by an airflow, converting or transforming same into mechanical energy for several purposes. Classic examples of this are the windmills, particularly those found in the Netherlands, Normandy and the Bay of Biscay, which are airfoils, namely sail cloth or the like stretched over suitable frames, rotating on a horizontal axis and placed in suitable position regarding the wind direction to take advantage of said incidental airflow.

For the past 30 years, the increasing cost of electricity generation and the investment needed for its transmission and distribution networks, coupled with the growing ecological problem caused by the discharge of CO₂ fumes in the atmosphere, have led to the research, development and creation of the so-called “renewable energies”, of which the use of the potential energy carried by the wind and converted into electrical or mechanical work is very promising. As a result, the eolic parks or “wind-farms” have been developed, generating electricity by means of a number of windmills driving electric generators, such as the one existing Oaxaca (Mexico), or near Bahia Blanca (Argentina), in which hundreds of tall columns have been installed, at the top of which are locate horizontal axis three blade rotors of several meters in diameter and associated to an alternator. These three bladed mills with its large dimensions produce another type of environmental pollution, developing a relevant amount of noise when turning the blades on its horizontal axis. They also have the inconvenience of a very steep construction, installation and maintenance costs. The high noise level they develop makes it impossible to install these devices in vicinity of populated areas. Moreover, these devices are known as “bird killers”severely depleting the flock of birds unfortunate to travel into their path.

Recently, particularly in Asia (China, Malaysia), in some Arab Emirates and in Punta del Este (Uruguay), we find buildings integrated with horizontal axis windmills generators, which blades rotates with a cowling. Also known are buildings formed by two towers spanned by a bridge, on which it is placed one or more horizontal axis windmills.

Due to their structural design and high environmental noise pollution, these three bladed horizontal axis windmills associated to the above said buildings have a relatively low performance, since the blade must have a shorter length than those installed in the wind-farms, hence their output does not always meet the total energy requirements of the associated building. Also, since the buildings are obviously static, it is impossible the properly channel the mass of air towards said mills under shifting wind directions.

The above problems have been partially solved employing vertical axis windmill designs, notably those of the Savonius kind. To this effect, there are known windmills such as the ones marketed in Spain under trademark “KILLUX®” and “EXAWIND®”, while in Argentina are sold under the brand “TALLER GALAN”.

Usually, the above said vertical axis windmills have a low or moderate output and they are usually found installed on the roofs of mobile homes or caravans, small buildings, or directly hanging from a balcony or window. In fact, it is known to have a large portico placed close to a residential building, with a battery of said vertical axis windmills placed side by side. The little noise generated by these windmills allows its proximity to towns, buildings or populated areas. The energy generated by these devices ranges from a few Kw/hour up to outputs in the range of several thousand Kw/hour (e.g.: 6,000 Kw/h), depending on the number of such devices and of course, of the prevailing wind speed.

Finally, it is worth mentioning patent U.S. Pat. No. 7,744,339 B, issued to California Energy & Power, teaching the use of a vertical axis windmill having its blades or rotor working associated to a curved airflow deflector positioned towards the wind direction defining a curved surface directing the wind against said vertical axis rotor. This windmill pivots on a vertical pole accepting the shifts in the wind direction, hence it can only have a single rotor per such construction, with the further disadvantage of leaving exposed the active portion of the rotor.

### PROBLEMS UNSOLVED BY THE EXISTING PRIOR ART

As a first step, analysing all the windmill designs known in the art, it is understood that even in the most ambitious projects, wind generators when aggregated or even incorporated into a building such as the constructions according to patents WO 2008/001080 A1, WO 2010/124692 A1 and US 2012/080884 A1, acts or functions independently of the to which they are associated. That is, the geometry and architecture of the construction does not alter or enhance the performance of the generator, and vice versa. In fact, in these known constructions, we have a mere juxtaposition of windmills to said buildings. Therefore, the generator does not take advantage of the geometry or design of the building's structure, and the result of this is that known windmills performs independently of the actual building's design.

It is also known that even with all current developments, wind power generation has a higher final cost when compared to a traditional electricity generation, especially in the stages in which the price of the oil barrel decreases significantly. This is due to the high initial installation and maintenance costs of wind generated electricity.

Precisely most of existing inconveniencies are detected when considering the issue of preventive maintenance of current horizontal axis windmills, since each blade of these large diameter rotors needs special equipment for inspection and eventual replacement, involving very steep disbursements.

As a result, the actual state of the art windmill generated electricity is considered as “environmentally clean energy production”, result which the most advanced government are tending to attain, being this the reason why the use of eolic energy for the obtaining electricity is usually encouraged by means of subsidies or loans of some importance, but said financial help does not entail negligible additional burden on the tax payers.

As above mentioned, wind farm facilities currently reflect a compromise between environmental pollution and a very high noise level developed by these facilities, hence it is not easy, and sometimes impossible, to consider having wind-farms coexisting or placed in proximity to habitable areas, hence subsists the problem of laying and transporting the generated electricity (distribution networks) to the end user. This implies also having to evaluate the depreciation of potentially habitable areas, which could attain a lower value if placed near these wind-farms.

Some of the well known above said solutions involves the installation of buildings with a series of vertical axis wind powered generators which, when fixed to said buildings, performs independently of the prevailing wind direction shifts, therefore these known constructions implies as above said a simple juxtaposition: that is, the windmill generator acts independently of the design or geometry of the building and regardless of the wind direction and its location to the building.

Another serious problem consists in regulating the airflow impinging on the rotor of the vertical axis windmill. In effect, whenever wind gusts develops wind speeds which may damage the rotors, according to the know technology there is no other resource than to feather the blades of the rotor, being the quite difficult to achieve with vertical axis devices, while on the other hand, if the wind's speed falls under a determined value, these devices may lose efficiency by not having an induced airflow strong enough to allow operating at a sustainable speed.

But a major problem facing known electricity generators driven by state of the art windmills and associated with existing constructions or buildings is that they are unable to efficiently channel the immense airflow towards suitable windmills providing an average steady laminar airflow, and even capable of increasing the wind's speed impinging on the rotors, hence they proved unable to take full advantage of the existing potential energy carried by the wind surrounding a building.

Further, it is also known that the mass of air incidental on a building moves at a faster rate the higher said building so having a design that manages to efficiently capture that energy irrespective of the building's height is also a problem pending to be solved.

The majority of the current constructions or buildings have a front surface against which the wind airflow collides causing an increased turbulent regime, especially at the building's edges or vertex, creating the detachment of the airflow from the building's surface, thus destroying any laminar airflow.

As a rule, the geometry of current constructions causes an increase of the airflow turbulence at its downwind edges (that is, the wind flow leaving the building's surface), so that another second construction having its own associated windmills cannot be placed downstream in proximity to the first building turbulent airflow leaving the upstream first building, hence a considerable distance must be provided between said two building or constructions.

Finally, there are safety problems associated with a rotating mass placed in vicinity of people transiting or dwelling said buildings, so it would be convenient to be able to enclose the vertical axis windmill rotors within a protective enclosure capable of avoiding accidental contacts with said rotors, while providing to dampen the level of noise issued by said windmills. Moreover, said enclosures prevents aesthetic disturbances damaging the harmony of the building's design conveniently hiding said rotors from sight.

### OBJECTS OF THIS INSTANT INVENTION

It is an object of this instant invention to maximize the wind energy surrounding a construction or building which has its volume submerged within an airstream.

It is also an object of this instant invention to design buildings or constructions capable of cooperating in directing and at the same time to accelerate a mostly laminar airstream driving it into the intake of at least one vertical axis rotor of an eolic generator incorporated into said construction or building.

Another object of this invention is to create a construction with a volume submerged into an airstream, capable of accelerating and laminating said airflow conveying said laminar airflow without discontinuities towards the inlet of the rotor of at least one vertical axis windmill linked to that building, placed at the proper places optimizing its generating capabilities.

It is also an object of this instant invention that said construction is a dwelling or apartment building, or workshop, factory, store or shed, while the energy output provided by aid of at least one windmill associated to said constructions satisfies or exceeds the total energy requirements of said building, workshop, factory or store, without depending on the input of any external energy distribution network.

It is also an object of this instant invention that these windmill generators associated to said constructions can operate continuously with airflows having a variable wind regime, both in wind speed as well as the wind direction.

It is yet another object of the invention that its capacity of electrical energy is independent of the variable direction of the incident airstream.

It is also an object of this instant invention to provide a structure or construction whose profile allows to reduce the turbulence of the thereon incident airflow and direct said airstream and capable of directing said airstream towards the vertical axis rotor inlet or intake of the generator(s) associated with said building.

A further object of this invention is that at least one windmill generator associated with the construction has at least one screen capable of providing soundproofing, as well as a protection against accidents due to physical exposure of people to the rotor and an aesthetic concealment by harmonizing the structure's visual appearance concealing said windmill

It is also an object of this instant invention to provide the less possible an downstream turbulence of the airstream leaving a first building in order to preserve the potential wind energy to be used by a second building placed downstream of the first building; in this way it is possible according to this invention to build whole neighbourhoods of dwellings and other constructions, each one with its own windmill generated electricity, which may also be integrated into a network or energy distribution grid covering this whole same neighbourhood.

It is a further object of this invention a building designed to cooperatively optimize the use of low cost windmill generators such as WAWT, by means of inserting into the building's volume the inactive portion of the rotor of said windmill which are not active and receiving the airflow which makes them turn, preventing said inactive portion to act as a brake to the rotational movement of said rotor and offering only the active part thereof to the incident wind direction.

Last, it is also an object of this invention to achieve a marked saving in the installation and maintenance costs with regards to the actual current cost present in the state of the art windmill generators having an equal output performance measured in the obtained Kw/h.

### SUMMARY OF THIS INVENTION

A CONSTRUCTION SUBMERGED INTO AN AIRSTREAM, DIRECTING AND ACCELERATING SAID AIRFLOW THROUGH AT LEAST ONE WINDMILL GENERATOR ASSOCIATED WITH SAID CONSTRUCTION, characterized in that it has at least one surface of said construction against which said airstream in incident, directing, accelerating and laminating the flow of air against the contour of the surface of said construction towards at least one windmill generator attached to said contour in an area where there is still no separation of said generally laminar airstream with respect to the wall of the construction facing said generator; at least one vertical plate is placed positioned in order that said at least one windmill generator is positioned between said plate and the contour portion of the building, establishing between said plate and construction an inlet and an outlet defining a channel for the passage of the airstream acting only on the active part of the rotor of said windmill; the entrance of said airflow channel directed towards the rotor of said at least one windmill is placed adjacent to the perimeter of the cross section perpendicular to the direction of the incidence of the airstream on said construction.

### DESCRIPTION OF THE PREFERRED EMBODIMENTS OF THIS INVENTION

in order to exemplify the preferred embodiments of this instant invention, the following drawings are attached, in support of the description thereof below given. These exemplary embodiments must be considered as one of the possible constructions of this invention, hence it is not appropriate to assign to them any limiting value of the scope of this invention, which is determined by the first claims below appended.

according to this instant invention, it can be considered that any construction built according to its teachings will prove more efficient in the generation of energy and in its task of generating as little as possible downstream turbulence in the airflow the more aerodynamic said constructions are in their final design. This is the reason why according to this invention, it is preferred to consider cylindrical buildings or constructions with a tapered horizontal cross section.

This instant invention is applicable to an ample variety of building's profiles or shapes and the following description of the invention explains one the most appropriate ways to achieve its proposed results.

Accordingly, it is hereby described the means by which it is possible, starting from an embodiment having a building or construction with a single windmill generator, to obtain a construction with a plurality of windmills placed conveniently at said construction perimeter at its cross section having a maximum diameter perpendicular to the incident airflow according to the prevailing wind direction, dependant of the need to take advantage of the airflow facing at any time a determined construction or building.

In the following Figures, the same references identifies similar or equivalent means as herein employed.

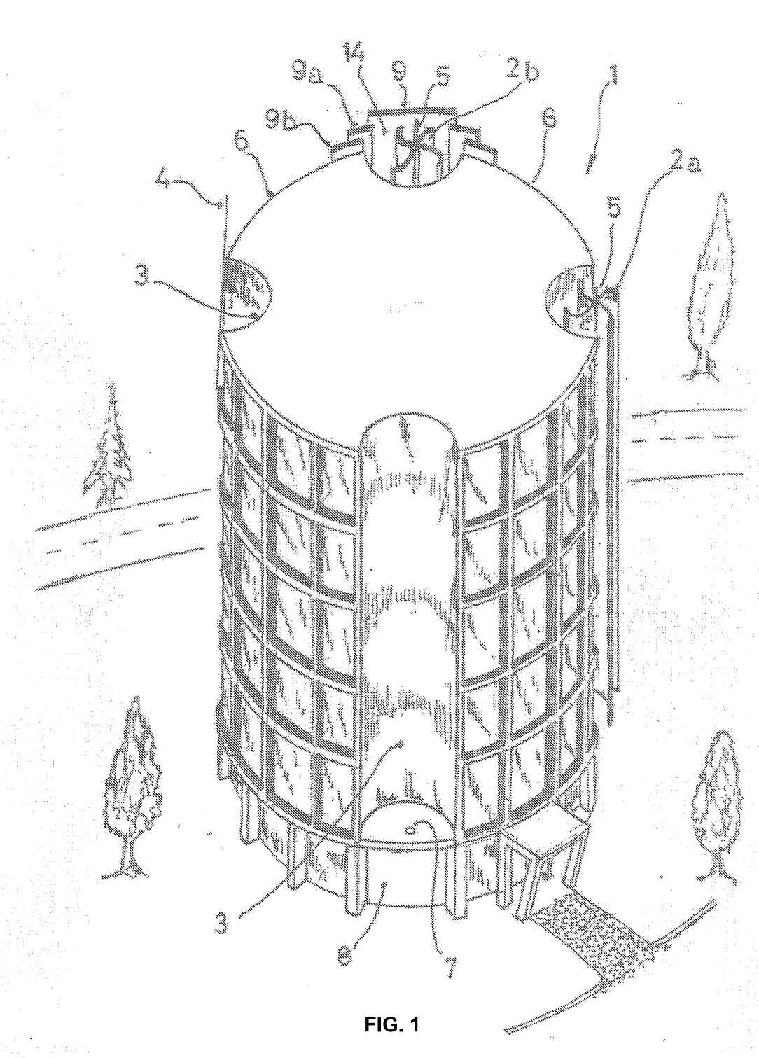

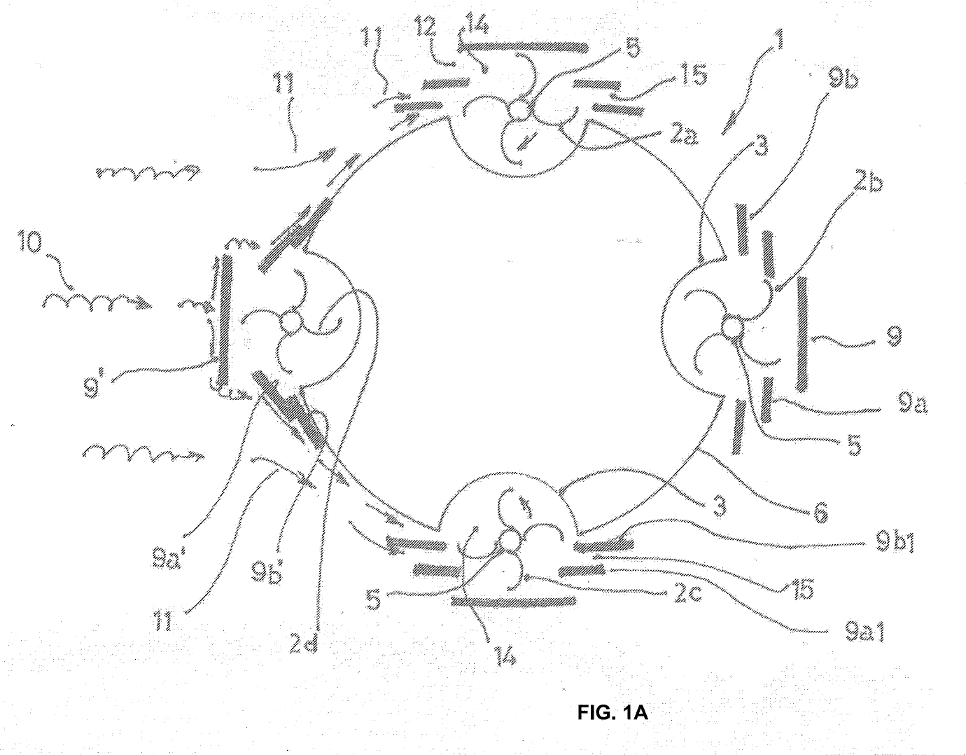

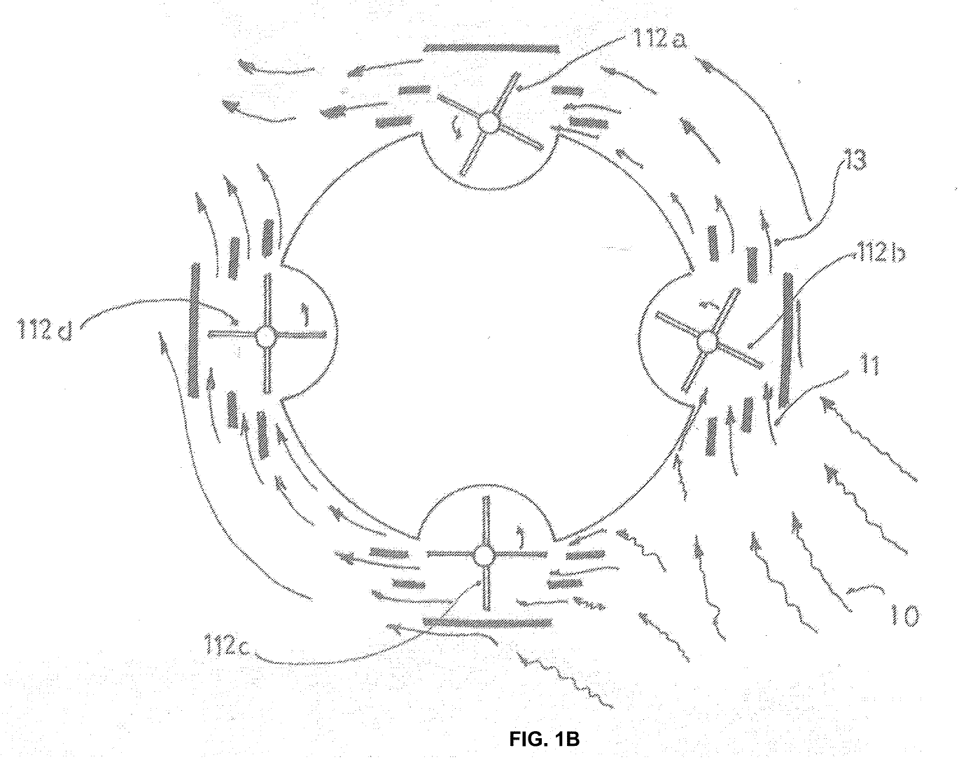

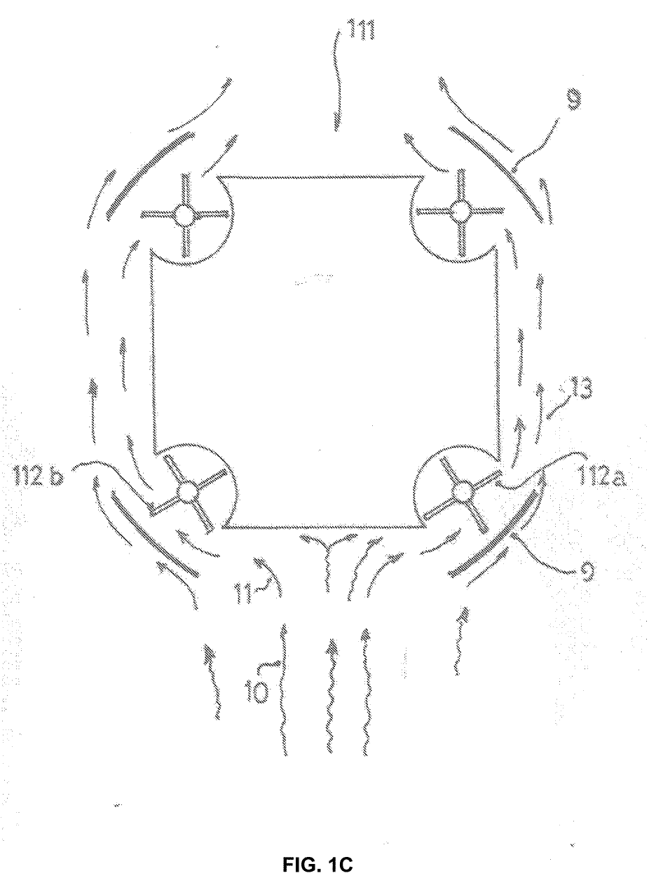

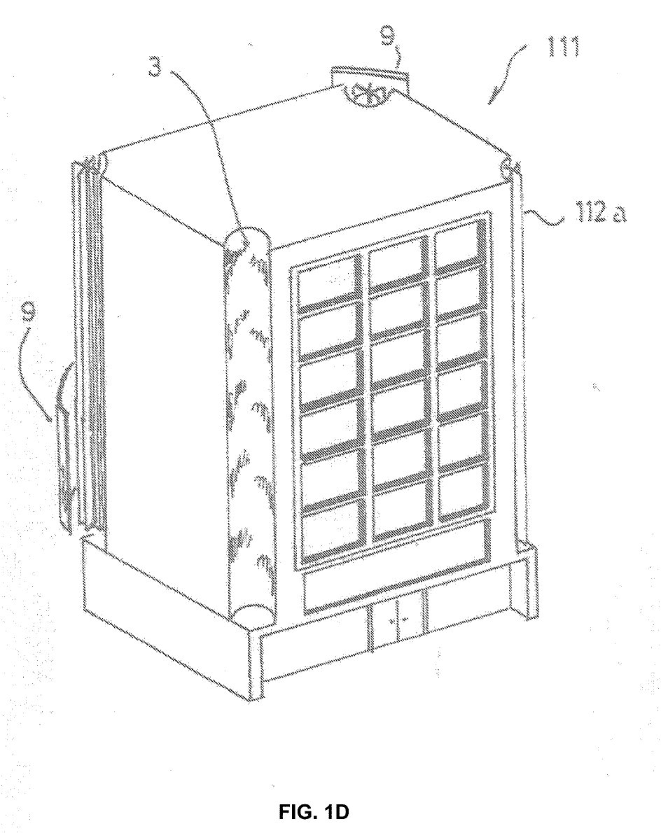

FIG. 1 depicts a perspective of a general building or construction showing the several stages of installation of the windmill generators according to this invention;

FIG. 1a is a top view of the embodiment of FIG. 1 schematically showing the incident airflow when facing said building.

FIG. 1b depicts the same top view of FIG. 1a but showing a wind-flow having a different incidence angle shifted 45° with regards of the wind-flow as per FIG. 1a.

FIG. 1c shows the upper view of a quadrangular cross section building having windmill generators almost entirely disposed within the apex of said quadrangular cross section improving the aerodynamics of the whole and the efficiency of the electricity generation.

FIG. 1d is a partial simplified perspective of one of the many possible constructions corresponding to the plan view of the previous figure.

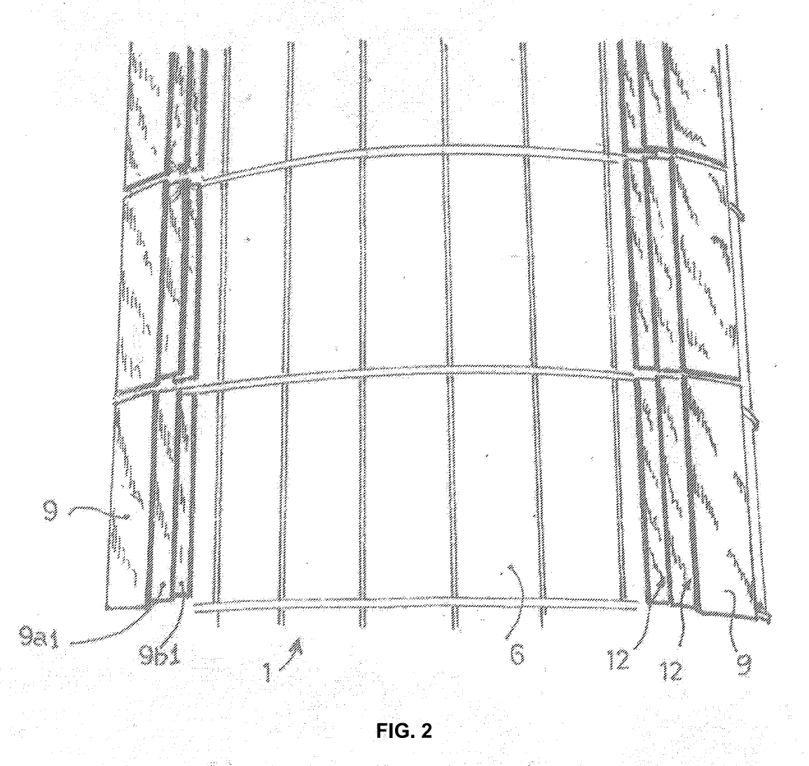

FIG. 2 is the perspective partial detail of a construction according to this invention showing same from its exterior, with the windmill enclosed and hidden by at least one plate or vertical screen.

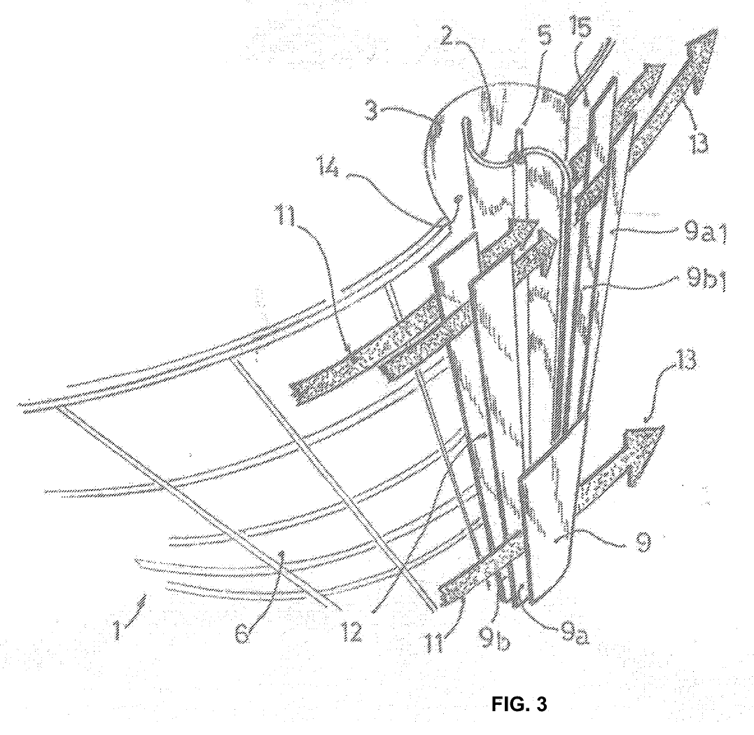

FIG. 3 shows in another perspective view the embodiment of FIG. 2, exemplifying the laminar airflow incident on one of the windmill generators of the building.

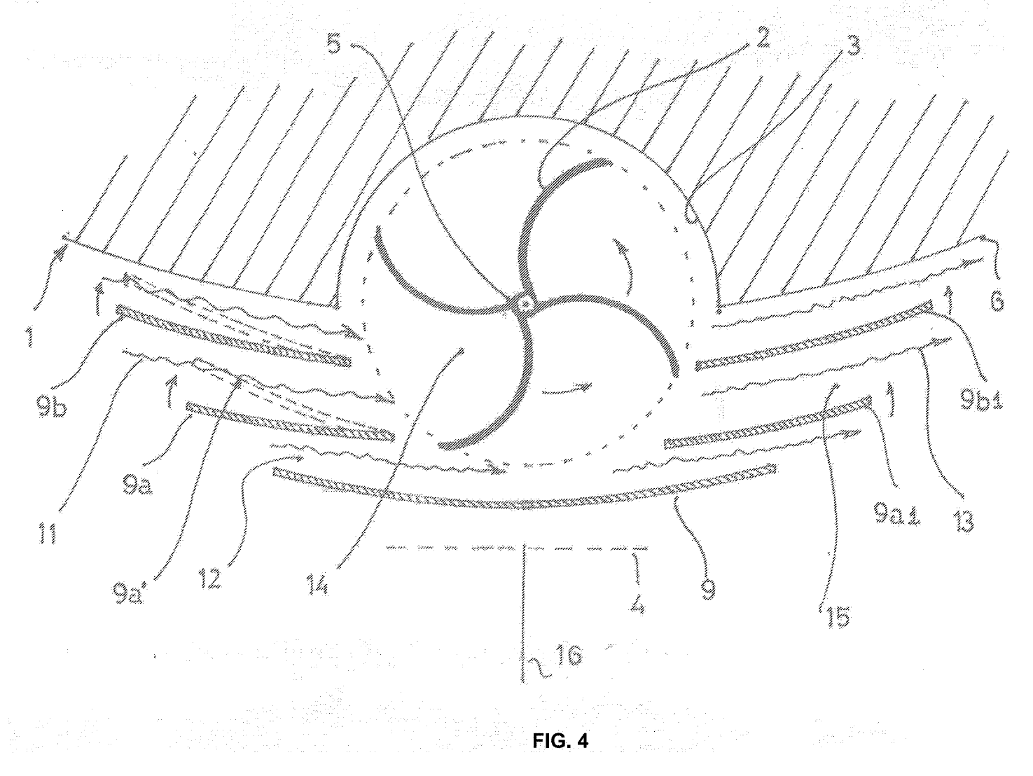

FIG. 4 is the horizontal cross section of an enlarged detail of FIG. 3.

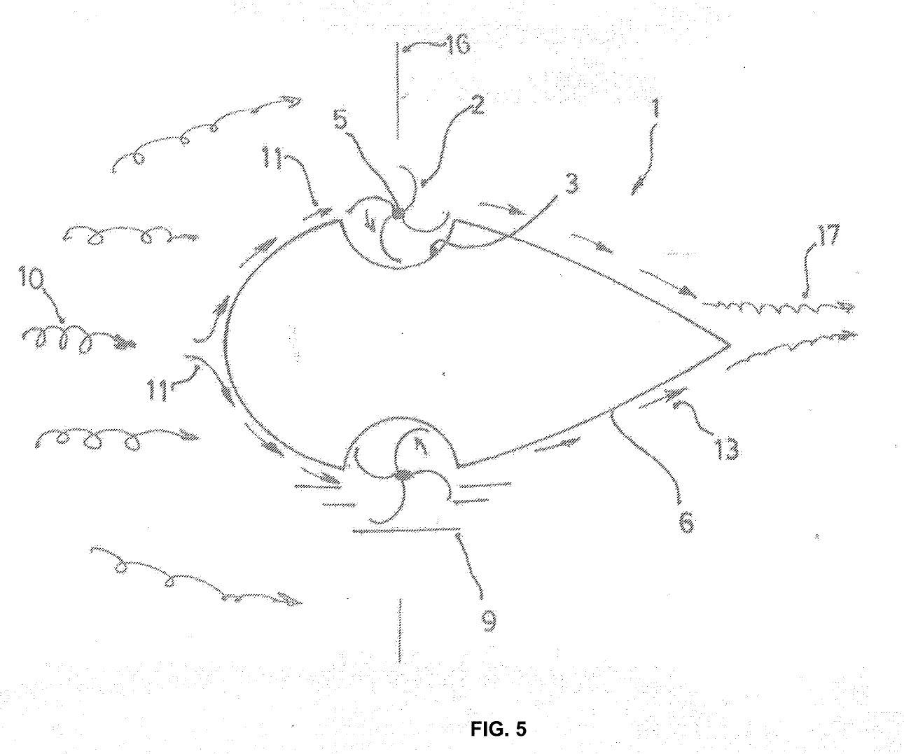

FIG. 5 shows in horizontal cross section another design or embodiment of this invention, showing the wind-flow laminar regime attained and acting upon de windmills.

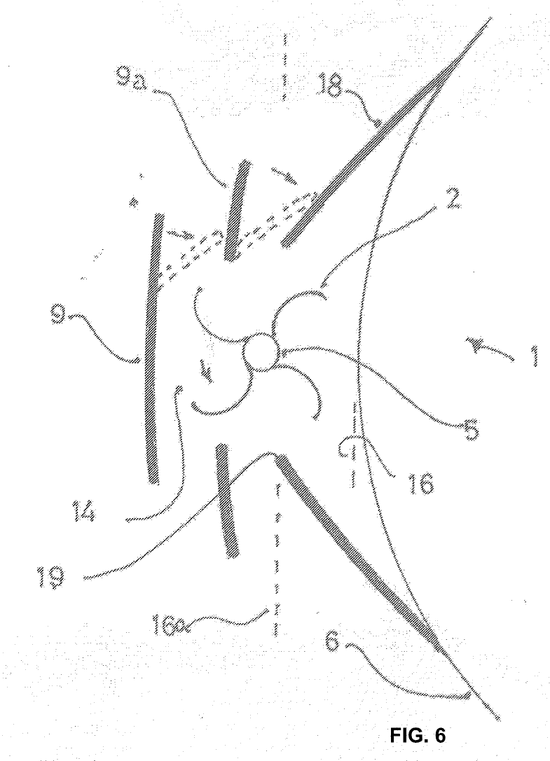

FIG. 6 is the horizontal cross section of yet another embodiment of this invention in which the windmill partial vertical housing is recreated by means by tangent plates affixed to the surfaces of the building thus avoiding to provide for the semi-cylindrical recess into which the windmill is placed, as per the previous figures.

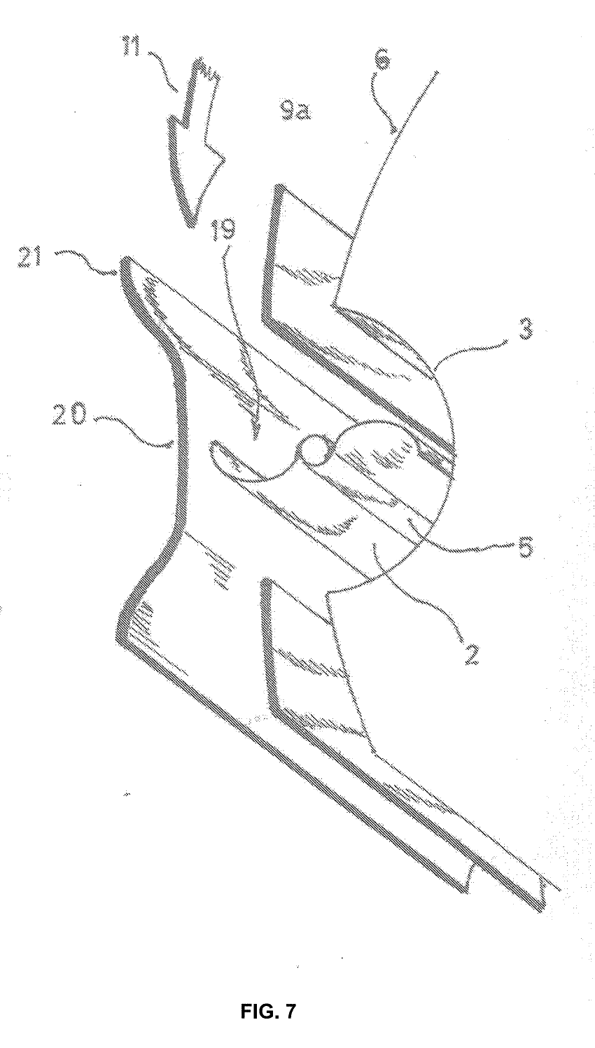

FIG. 7 shows the simplified and perspective section of a series of plates arrangement by means of which a venture effect is obtained on the air-flow acting on the rotor of the windmill.

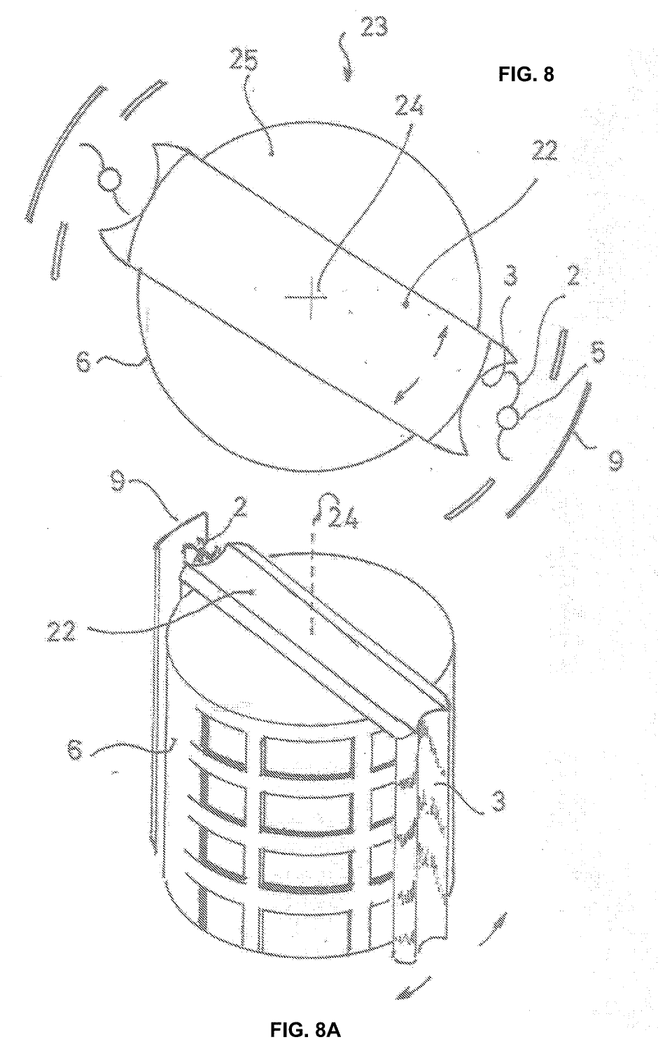

FIG. 8 shows the top view of yet another construction of this instant invention in which the windmill generators are arranged tangent to a building having a circular plan and placed upon a diametral bridge capable of rotating on the vertical axis of said building.

FIG. 8a is a simplified perspective view of FIG. 8.

In said figures, is generally indicated by reference (1) a construction according to one of the embodiments of this instant invention. This construction may be a housing unit, a factory or offices structure, or as shown in FIGS. 1 to 3, it is a multiple floors construction, such as an apartment building. In said FIGS. 1, 1a and 1b, said building has a circular plan. This is specifically designed when said building is affected by a variable wind direction air-flow, striving to provide a building profile to the wind as aerodynamic as possible in order to increase the overall efficiency of the generating units associated to said construction. Hence the need to have a circular layout having four vertical axis windmill generators placed at 90° the from the other so to allow at least one of them to perform efficiently irrespective of the actual direction of the incident wind.

Also, while this invention is also applicable to windmills having rotors with both vertical and horizontal axis, same is preferably applied to vertical axis devices, and particularly those of the “Savonius” kind, with the possibility that the blades of its rotor are either of a curved or flat cross section, including profiles of variable curvature. According to this embodiment, the building's structure conceals from the aerodynamic point of view of the incidence of the wind on the blades of the rotor advancing (meaning turning on its axis) against said air-flow direction, leaving exposed to said air-flow only the blades turning with the wind. This also allows to generator to be equally efficient with winds entering from one direction or from the opposite direction in the windmill generation area. Accordingly, the construction depicted in FIG. 1 sports four orthogonally arranged Savonius windmills (2), of which in said figure only two of them, namely (2a, 2b), are shown. According to a preferred embodiment of this invention, these generators (2) are placed within semi cylindrical recesses (3) of a constant diameter cross section such that their diameter (4) is at least partially tangent to the curved profile (6) of the building's cross section and substantially coincides with the axis (5) of said windmill (2) placed within each semi-circular recess (3).

Also, according to FIG. 1, the lower end of shaft (5) of each generator (2) may pass through a passage (7) penetrating into a chamber (8) wherein the electricity generator or other related devices such as converters and storage of the obtained electric power. The upper end of shaft (5) can be inserted into a bushing or ball bearing (not shown) placed coincidental with the height of the vertical shaft of said windmill in a support arranged for this purpose at the top of the building.

According to this instant invention it is placed at least one vertical plate or screen (9) facing each windmill generator (2), and preferably it is placed a series of stepped screens (9, 9a, 9b) for the purpose down below explained.

FIG. 1a shows a top view of the building of FIG. 1, wherein it is observed an eventual incident turbulent wind-flow (10) of the airstream impinging the screen or plate (9)′ facing it; the other plates or screens (9a, 9b) acts as inlet dampers, which in some embodiments of this same invention are adjustable dampers limiting the inflow of air to the corresponding windmill (2d) by turning on an axis to (9a′, 9b′) streamlining the sector which may not be active in its generation capability, since by blocking the air inlet it prevents to incident air-flow driving the windmill generator in its rotational displacement. Said turbulent air-flow (10) begins to laminate upon reaching the plates placed in the depicted position (9a′, 9b′) transforming said turbulent wind regime into a laminar air-flow (11) hugging the construction s surface. It is thus accelerated and it adds to the other air-stream surrounding that sector of the building and then enters into inlet (12) tangent to the outer surface (6) of said building. When accelerating, coincidental with Bernoulli's Law, the air-flow facing the building at a certain speed, tends to concentrate its energy in a smaller section captured in that circumstance by the appropriately arranged windmills. The consequence is that by using windmill rotors of a smaller diameter it is possible to obtain more energy than if it were arranged in a free air-flow. We may recall that the aerodynamic force depends on the square of the speed of the air-stream wind mass.

FIG. 1a shows a plan view of the building of FIG. 1 with the series of plates or screens (9, 9a, 9b) whereby it is achieved a plurality of inlet ports (12) parallel to each other providing to laminate the airstream (11)acting upon the corresponding windmill generator (2), which in this particular case are windmills (2a, 2c) therefore increasing the efficiency and performance thereof

FIG. 1b, assuming a constant turbulent airflow (10) helps to show how the variation of incidence of the damper plates on the building does not vary significantly the energy generating capacity or performance of the associated windmills. In fact, a 45° displacement in the direction of the incident wind according to precedent FIG. 1a, can be observed in this FIG. 1b. In the latter case, the active vertical axis windmill generators are of the kind sporting flat blades (112b, 112c). The air mass flow is divided into two streams and after generating a rotational movement at (112b, 112c), exits aligned and oriented thanks to the downstream deflectors, which in turn reduces the tendency of the airflow limit layer to separate from the building's wall, whereby achieving a laminar flow regime, capable to induce the generation of an additional rotational movement in the other windmills (112d, 112a), hence increasing the overall generation output, developed by the same building or structure. This figure also shows the virtue of accelerating and channelling towards the vertical axis windmills a large part of the airflow facing the building.

FIGS. 1d and 1d shows a further embodiment of this invention wherein the building (111) has a quadrangular plant cross section, e.g., a substantially prismatic building. In this embodiment of the invention the windmill generators (112) (in this case having flat bladed rotors) are placed almost entirely within the cross section of the building to improve the overall aerodynamic generation efficiency. It is also observed (see FIG. 1c) how the plates or screens acting as blinds or dampers benefits the proper orientation of the air-flow increasing the output of all the generators and improves the aerodynamics of the whole. FIG. 1d shows the vertical axis windmill generators in several stages of the installation or fitting to the building.

FIGS. 1, 2 and 3 allows observing that according to an embodiment of this invention, notwithstanding the eventual use of horizontal axis windmills, it is preferred to employ vertical axis windmills, and the latter may extend to almost the total height of the building. This is not a capricious disposition, and in fact, by occupying most or all the height of the building's laterals, the airstream is forced through the windmill's blades of the rotor, creating a tunnel effect capable of channelling the air-flow, whereas, if we have installed in the building only one windmill of discrete or discontinuous length, the air-flow according to Fermat Principle, chooses to take the path of minimum energy consumption, that is, it passes preferably where there are less or no obstacles, hence avoiding the rotor s blades.

FIG. 2 shows a perspective partial lateral view of the construction (1). In this figure it is observed that plates (9, 9a, 9b) although they constitute each one and individually a continuous surface, they are sectioned to aid its eventual replacement, when necessary, and the rotors (2) are also sectioned (not shown) for the same purpose. As seen in this FIG. 2, these plates (9, 9a, 9b) defines multiple inlets (12).

Said damper plates or panels (9, 9a, 9b) placed along the building's wall and facing it defines a passage or air tunnel (14) within which it is placed the rotor of the windmill generator (2). FIG. 3 depicts a very interesting particularity of this invention, while in FIG. 4 we find that in the preferred construction therein illustrated the laminar air-flow (11) entering the air tunnel (14) through inlets (12) undergoes a conversion from a laminar flow into a turbulent air-flow due to the agitation generated at the outlet (15) by the rotating blades of (2), but plates (9, 9a1, 9b1) which together with surface (6) of the construction defines the outlets (15) of the laminar flow (13), helps to again align the air-flow and retard the detachment thereof from the wall of the building downstream of the generator, reducing the turbulence left over in order that said airstream can be used by other downstream buildings having these same windmill generators, which may then placed downstream close to the upstream building. This minimizes the turbulent action of the rotating blades of each generator, allowing similar buildings to be placed downstream. This novel result cannot be obtained by the cited prior art known up to date, associated with a building or construction.

FIG. 4, complementing FIG. 3, further shows a construction in which the pivotal ends of some of the plates or screens, such as plate (9a′) acts as a damper of the airstream entering tunnel (14). This embodiment is particularly important since it enables to regulate and eventually close the air intake to the tunnel (14) in the event of adverse weather conditions such as stiff winds, storms, etc. As shown in FIG. 4, axis (5) of the windmill's rotor (2) is placed tangent to the outer surface (6) of the construction (e.g.: tangent to the inlet of recess 3), while this recess (3) is placed in vicinity of the portion of larger diameter (16) of the curved surface (6) of said construction.

FIG. 5 illustrates a further profile given to a building and/or construction suitable to the ends of this invention. Here we may see that the profile of the construction (1) has lateral surfaces (6) with a drop-like cross section helping to produce at its outlet (17) a low amount of turbulence. This particular profile is ideal for winds having a defined direction tendency or for situations in which the totality of the construction could be oriented with respect to the variable wind direction. The advantage of the above is that the installed generation capacity always operates at its maximum potential. In these particular embodiments the use of concave-convex type blades in a Savonius windmill is a valid option since the s wind always prevails from the same direction relative to the horizontal axis of the building.

FIG. 6 shows yet another embodiment of this invention, wherein whenever it is desired or is impractical to define a semi-circular recess (3) on surfaces (6) as in the previous figures, then it is possible to provide plates (18) eventually placed tangent to (6) and with its free ends (19) reaching line (16a) representing the vertical plane containing said edges (19), being (16a) parallel to wall (6) or the tangent (16) thereof, and in coincidence with axis (5) of rotor (2).

FIG. 7 shows another embodiment of this invention. As already seen in the previous embodiments, a tunnel (14) is formed between plates (9) and the side wall (6) of the construction, with the eventual inclusion of the vertical recess (3) wherein is directed the incident laminated air-flow (11) on the rotor (2). In said FIG. 7, the tunnel (19) is formed by a plate having its ends (21)spaced from wall (6) and plates (9a) with a central depression (20) restricting the flow of the incident air-flow increasing its speed by applying Bernoulli theorem, taking advantage of the relative height of said tunnel (19) and the upper and lower closures thereof (not shown), whereby the mass of air must necessarily accelerate in line with the rotor's blades of generator (2). The embodiment of FIG. 7 is applicable to all constructions of this instant invention.

FIG. 8 shows a top plan view of another embodiment of this invention wherein it is possible to place the windmill generators (2) integrated to a bridge or gantry (22), rotating about its vertical axis (24)on a circular construction (23), thus allowing said windmills to be placed in an optimum position according to the incident shifting wind direction. This arrangement is placed contiguous with the entire lateral wall (6) or around the perimeter of the building, including its roof (25), rotating about the longitudinal axis thereof. This same embodiment may be applied to semi-conical or semi-spherical constructions (not shown) or any construction having a horizontal circular cross section, allowing this bridge or portico carrying said windmills to rotate on the vertical axis of the building while maintaining a minimum distance from walls (6) or lateral profile so that the advantages provided by this invention can be efficiently applied.

It should be noticed that in all the above figures, the bonding of plates (9), their possible displacement when acting as dampers, and the present linking of the windmills (2) is not detailed since they are matters known in the art.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. An air-flow submerged construction configured to direct and accelerate air-flow through at least one windmill generator associated with said construction, comprising:
at least one surface against which said air-flow is incident, wherein the at least one surface is configured to direct and accelerate the air-flow against a contour of the at least one surface towards the at least one windmill generator;
at least one vertically placed plate positioned to face said windmill generator, wherein the least one windmill generator is positioned between the at least one vertically placed plate and said contour of the at least one surface;
an air tunnel formed by and between the at least one surface and the at least one vertically placed plate, the air tunnel comprising an inlet and an outlet and configured to channel said air-flow to act on blades of said windmill generator; and
wherein said inlet is positioned perpendicular to the air-flow direction incident on said construction.

15. The air-flow submerged construction of claim 14, wherein the at least one windmill generator comprises a windmill rotor with a horizontal axis or a vertical axis.

16. The air-flow submerged construction of claim 15, wherein a windmill rotor comprising a vertical axis is of a WAWT type and particularly of a Savonius design.

17. The air-flow submerged construction of claim 14, wherein the at least one surface is a flat wall surface or a curved wall surface.

18. The air-flow submerged construction of claim 14, wherein the at least one vertically placed plate comprises:
a first outer plate;
at least two semi-plates substantially parallel to and separated from the first outer plate wherein the at least two semi-plates are positioned between said first outer plate and an external surface of said construction;
wherein the at least two semi-plates are laterally offset respective to the first outer plate in both the inlet and outlet openings of the air-flow within said tunnel.

19. The air-flow submerged construction of claim 14, wherein said air tunnel comprises a vertical recess on a lateral side of the construction, said vertical recess positioned opposite said at least one vertically placed plate.

20. The air-flow submerged construction of claim 19, wherein said vertical recess comprises a circular cross-section of a larger radius than a radius defined by a rotor of the windmill generator.

21. The air-flow submerged construction of claim 18, wherein at least one of the at least two semi-plates is selectively displaceable on a vertical axis thereof, and defines an entry and/or exit damper of the air-flow within said tunnel wherein the windmill generator is placed.

22. The air-flow submerged construction of claim 14, wherein said at least one vertically placed plate comprise a portion facing the windmill's rotor axis with two end flaps outwardly curved, and defines a vertical axis Venturi duct. cm 23. The air-flow submerged construction of claim 14, wherein said at least one windmill generator is positioned on a gantry or bridge capable of a rotational displacement about a geometric center of a circular section of a construction, and wherein said at least one windmill generator is attached to an area of said gantry near a lateral wall or the roof of said construction.

24. The air-flow submerged construction of claim 14, wherein said air tunnel is formed by two or more vertical oblique plates connected to construction, wherein the two or more vertical oblique plates are separated from each other and comprise opposite slopes, wherein the windmill generator is positioned between the two or more vertical oblique plates.

25. The air-flow submerged construction of claim 14, comprising a plurality of windmill generators, each of said plurality of windmill generators substantially positioned along one or more lateral sides of the construction, wherein the plurality of windmill generators are aligned in pairs positioned on opposing sides of said construction.

26. The air-flow submerged construction of claim 14, wherein said windmill generator is positioned adjacent to a perimeter of the construction and perpendicular to a direction of the wind, and occupies at least partially said perimeter.
